(19) United States
(12) Patent Application Publication
(10) Pub. No.: US 2016/0201415 A1
(43) Pub. Date: Jul. 14, 2016

(54) METHOD OF FORMING A SLIP CONE

(71) Applicant: Randall V. Guest, Spring, TX (US)

(72) Inventor: Randall V. Guest, Spring, TX (US)

(73) Assignee: Baker Hughes Incorporated, Houston, TX (US)

(21) Appl. No.: 14/596,885

(22) Filed: Jan. 14, 2015

(51) Int. Cl. E21B 23/01; B29C 70/08; B29C 70/30; B29C 71/02

(52) U.S. Cl. CPC E21B 23/01; B29C 71/02; B29C 70/08; B29C 70/30; B29L 2009/00

(57) ABSTRACT

A method of forming a slip cone includes winding a slip cone material onto a mandrel to create at least one slip cone preform having a plurality of layers. At least one of the plurality of layers is inclined relative to the mandrel. The slip cone preform is removed from the mandrel and processed to form at least one slip cone.

### BACKGROUND

Hydrocarbon recovery and exploration service companies employ downhole tools that perform a wide variety of functions. For example, tools may be deployed in a wellbore to isolate one portion of a formation from another. In some cases, it is desirable to anchor the tool in the wellbore. Anchoring may be achieved through the use of a slip and cone system. The slip and cone system may include one or more slips and cones arranged about a mandrel. The slip includes a tapered surface that is shaped to engage with a tapered surface of the cone. An axial force causes the slip to shift along the tapered surface of the cone. The slip expands radially outwardly engaging with an inner surface of the wellbore. A number of slips and corresponding cones may be employed to anchor the downhole tool to the wellbore. Given the ubiquitous use of slips and cones, the industry would welcome improvements in cone design and construction.

### SUMMARY

A method of forming a slip cone includes winding a slip cone material onto a mandrel to create at least one slip cone preform having a plurality of layers. At least one of the plurality of layers is inclined relative to the mandrel. The slip cone preform is removed from the mandrel and processed to form at least one slip cone.

A slip cone includes a body formed from a plurality of layered windings of slip cone material. At least one of the layered windings being inclined relative to others of the plurality of windings.

A resource recovery system includes an uphole system, and a downhole system including at least one downhole tool. The at least one downhole tool includes a slip cone having a body formed from a plurality of layered windings of slip cone material. At least one of the layered windings being inclined relative to others of the plurality of windings.

### BRIEF DESCRIPTION OF THE DRAWINGS

Referring now to the drawings wherein like elements are numbered alike in the several Figures:

FIG. 1 depicts a subsurface exploration system including a tubular supporting a slip cone formed in accordance with an exemplary embodiment;

FIG. 2 depicts a slip cone formed in accordance with an exemplary embodiment;

FIG. 3 depicts a layer of a slip cone material being laid onto a mandrel, in accordance with an exemplary embodiment;

FIG. 4 depicts another layer of a slip cone material being laid onto a mandrel, in accordance with an exemplary embodiment;

FIG. 5 depicts yet another layer of a slip cone material being laid onto a mandrel, in accordance with an exemplary embodiment;

FIG. 6 depicts a partial cross-sectional view of a slip cone formed in accordance with an exemplary embodiment;

FIG. 7 depicts an un-cured slip cone form covered in a consolidation layer prior to curing; and

FIG. 8 depicts a cured slip cone form, in accordance with an exemplary embodiment.

### DETAILED DESCRIPTION

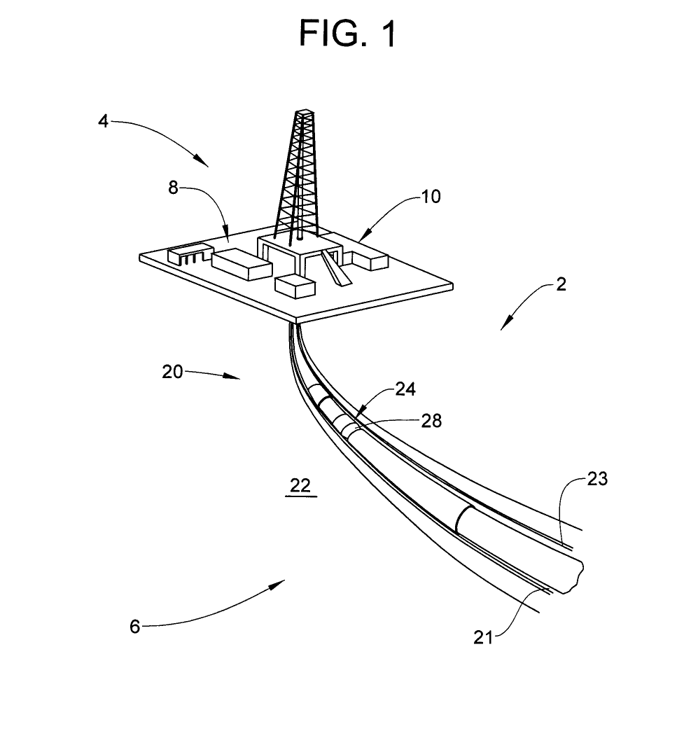

A subsurface exploration system, in accordance with an exemplary embodiment, is indicated generally at 2, in FIG. 1. Subsurface exploration system 2 should be understood to include well drilling operations, resource extraction and recovery, CO₂ sequestration and the like. Subsurface exploration system 2 may include an uphole system 4 operatively connected to a downhole system 6. Uphole system 4 may include pumps 8 that aid in completion and/or extraction processes as well as fluid storage 10. Fluid storage 10 may contain a completion fluid that is introduced into downhole system 6. Downhole system 6 may include a downhole string 20 that is extended into a wellbore 21 formed in formation 22. Wellbore 21 may include a wellbore casing 23. Downhole string 20 may include a number of connected downhole tools or tubulars 24. One of tubulars 24 may support a slip cone 28.

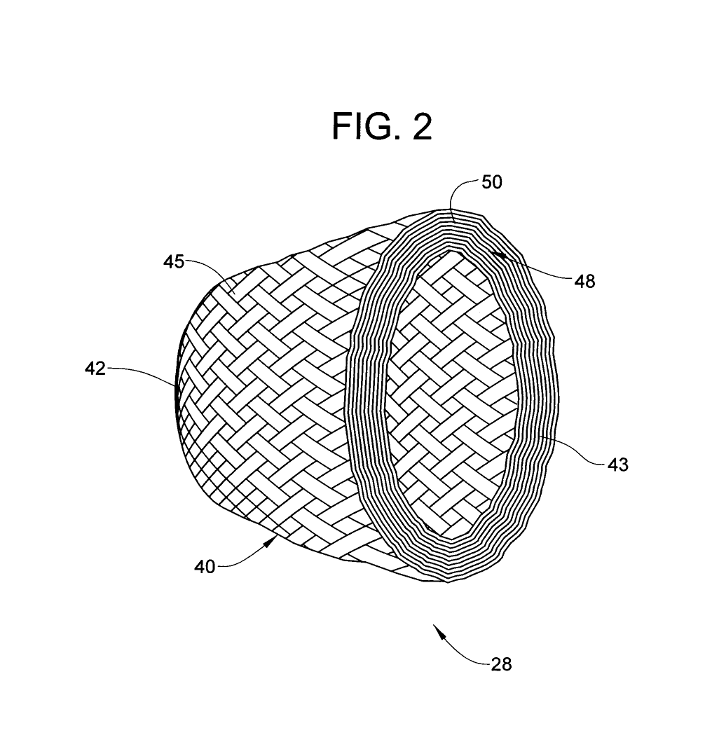

FIG. 2 depicts slip cone 28 including a body 40, a first end 42, an opposing, second end 43, and an intermediate portion 45 extending therebetween. As will be detailed more fully below, body 40 is formed from a plurality of layered windings 48 of a continuous slip cone material 50 which takes the form of a fiber. The fiber may take a variety of forms. For instance, slip cone material 50 may take the form of a tow. In accordance with an exemplary embodiment, slip cone material 50 make take the form of a carbon fiber tow. The term “tow” should be understood to include a band of tows. Slip cone material 50 may also take the form of a roving. In accordance with an aspect of an exemplary embodiment, slip cone material 50 may take the form of a carbon fiber roving. The term “roving” should be understood to include a band of rovings. Slip cone material 50 may also take the form of a prepreg tow or a wet resin impregnated tow or fiber. Slip cone material may also take the form of a prepreg roving or a resin impregnated roving or fiber. Slip cone material 50 may also take the form of a wet tow or a wet roving. By wet, it should be understood that the tow or roving may be completely or partially saturated and coated in a resin. Slip cone material 50 may also take the form of a dry tow or a dry roving that may later be impregnated with a resin.

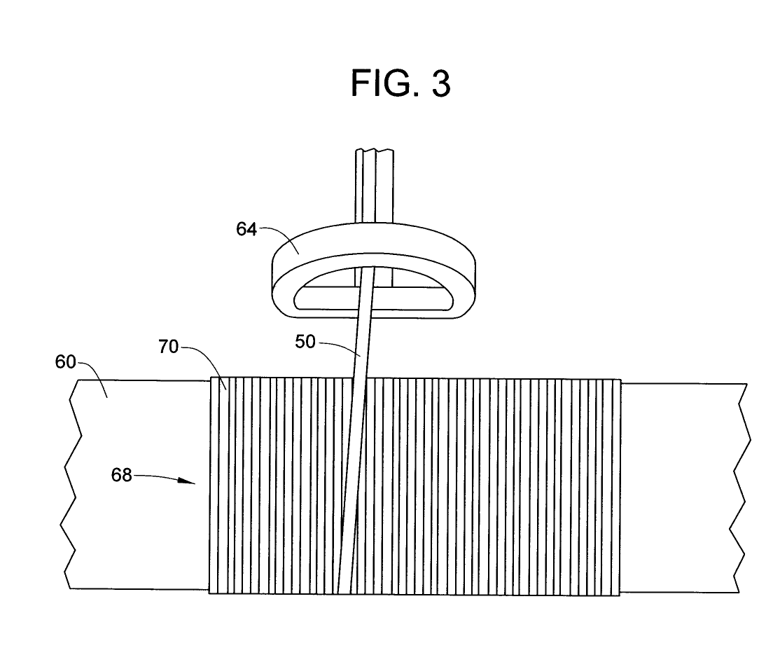

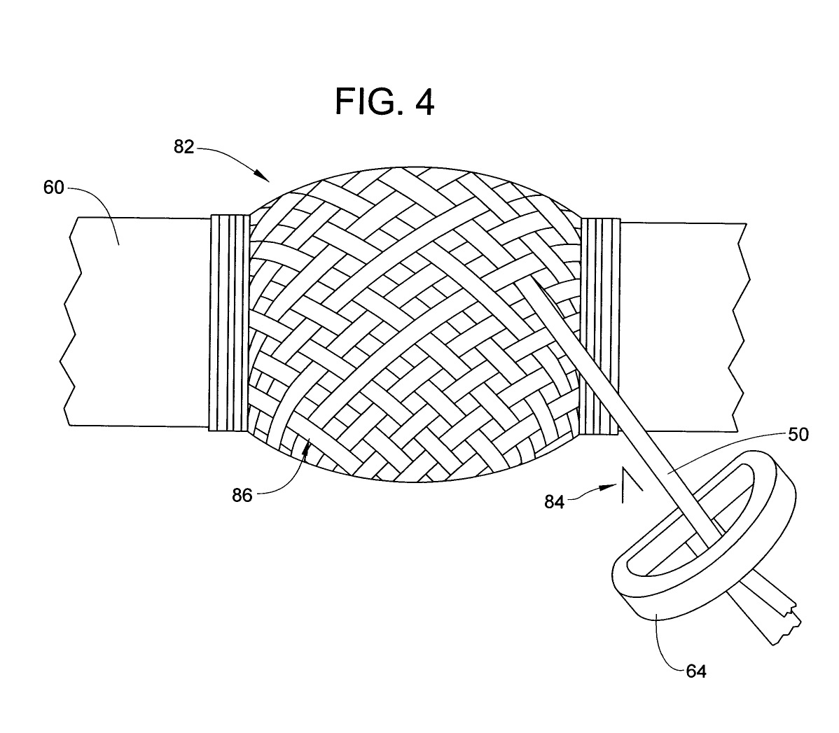

As shown in FIG. 3, slip cone material 50 is laid down or wound onto a mandrel 60. Slip cone material 50 may be wound onto mandrel 60 as a continuous fiber. Alternatively, slip cone material 50 may be wound onto mandrel 60 as a discontinuous fiber. For example, if slip cone material 50 breaks, fibers may be joined or a new fiber started. Further, it may be desirable to employ different fibers to achieve selected mechanical properties of slip cone 28. A winding machine, a portion of which is shown at 64, lays down a first layer 68 onto mandrel 60. First layer 68 may take the form of a circumferential, hoop, or circular wind layer 70. A circular wind layer 70 represents substantially perpendicular winds, or winds that are about 90° relative to mandrel 60. A second or subsequent layer 82 is laid over circular wind layer 70, as shown in FIG. 4. It should be understood that second layer 82 need not be wound directly onto circular wind layer 70. More specifically, layers 48 may be laid onto mandrel 60 in a variety of sequences. Second layer 82 is wound onto mandrel 60 at a non-circular or non-perpendicular angle 84 to form a helical wind layer 86. The particular degree of non-perpendicular angle 84 may vary.

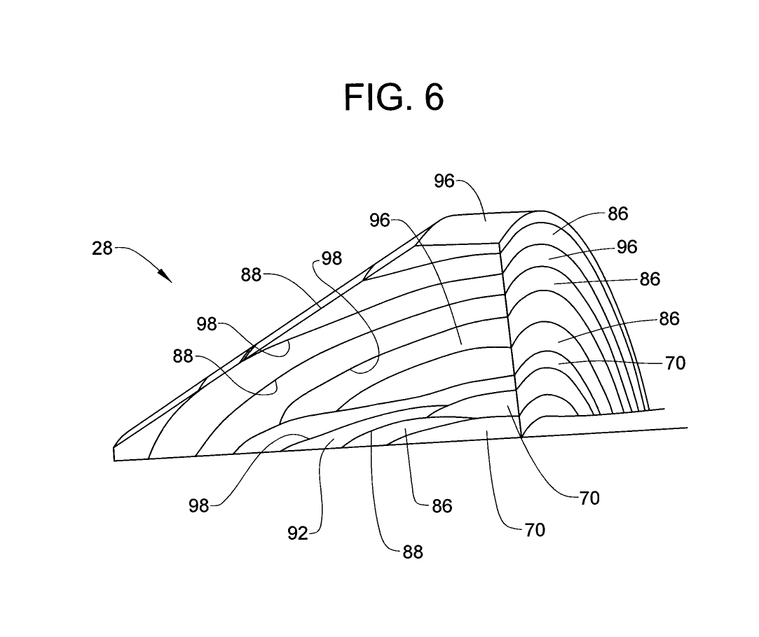

A helical wind layer includes turn-around regions (not separately labeled). A central section (also not separately labeled) of helical wind layer 86 arranged between the turn-around regions will possess a constant winding angle of slip cone material 50. Further, helical wind layer 86 is inclined relative to circular wind layer 70 and mandrel 60. More specifically, helical wind layer 86 includes two inclined regions, one of which is shown at 88 in FIG. 6, that do not run parallel to circular wind layer. The two inclined regions 88 are arranged in either side of the central section. The inclined regions 88 contribute to enhancing an overall strength of slip cone 28. That is, the inclined regions 88 enable slip cone 28 to better resist shear forces that may exist downhole.

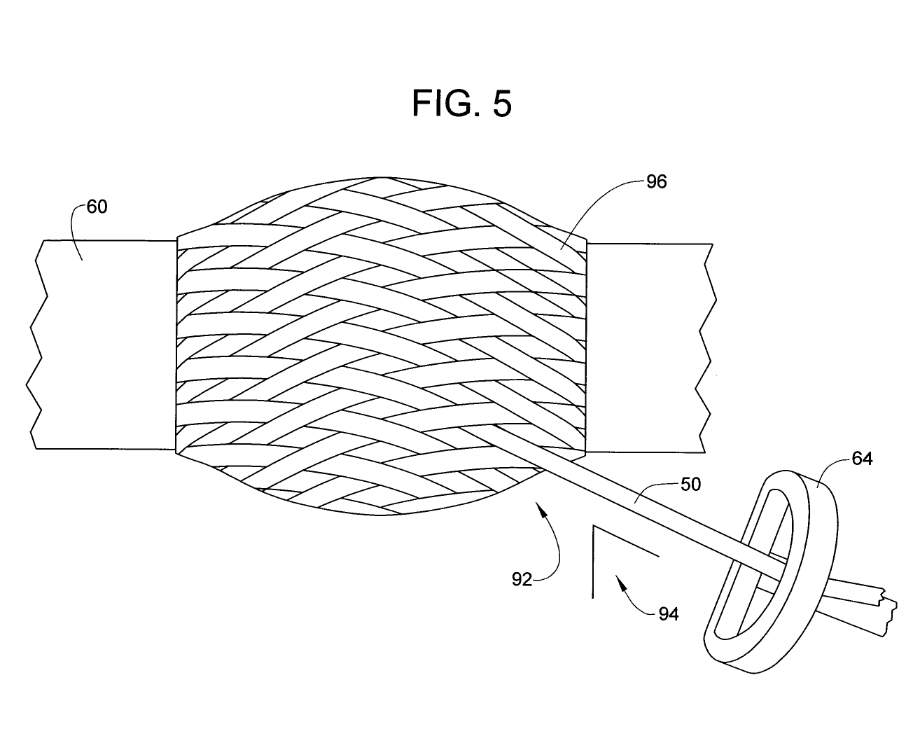

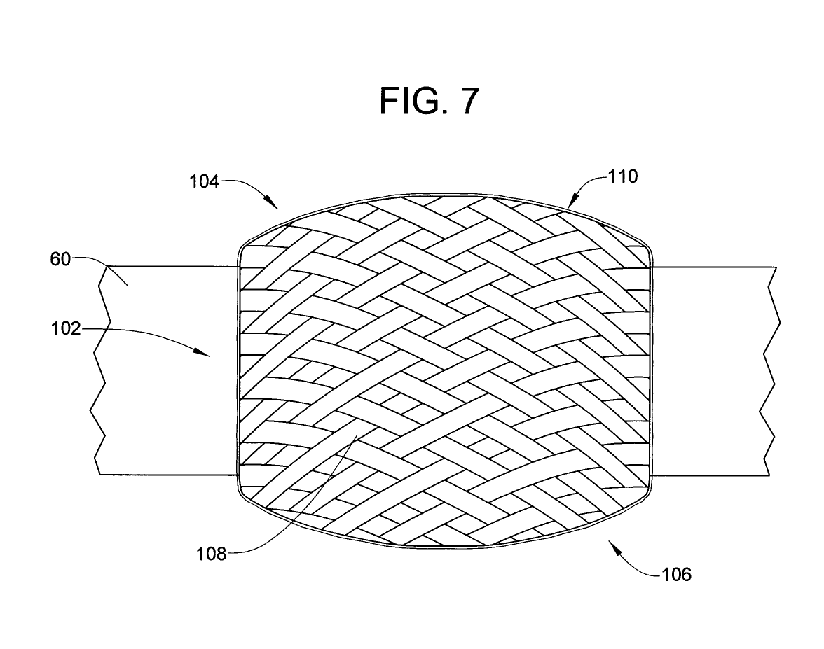

FIG. 5 depicts a third layer 92 that may be laid over first layer 68 and or second layer 82. Third layer 92 is also laid down at a non-circular or non-perpendicular angle 94 relative to mandrel 60 to establish a non-circular or bottle wind layer 96. Bottle wind layer 96 includes inclined regions, one of which is shown at 98, and forms polar openings (not separately labeled). Bottle wind layer 96 may include an ellipsoidal dome profile, an isotensoid profile, or other geometric characteristic. Winding machine 64 continues to lay down layers 48 that include hoop layers and inclined layers, e.g., helical wind layer 86 and bottle wind layer 96 onto mandrel 60, as shown in FIG. 6, until a selected un-cured slip cone preform 102 is established having a selected geometry, selected diameter, and a selected length, as shown in FIG. 7. Un-cured slip cone preform 102 includes a first slip cone portion 104 and a second, opposing slip cone portion 106. First slip cone portion 104 includes layers that are inclined relative to mandrel 60 in a first orientation and second slip cone portion 106 includes layers that are inclined relative to mandrel 60 in a second orientation. The inclined layers of each of the first and second slip cone portions 104, 106 extend from mandrel 60 towards the central section. At this point, un-cured slip cone preform 102 may be removed from mandrel 60.

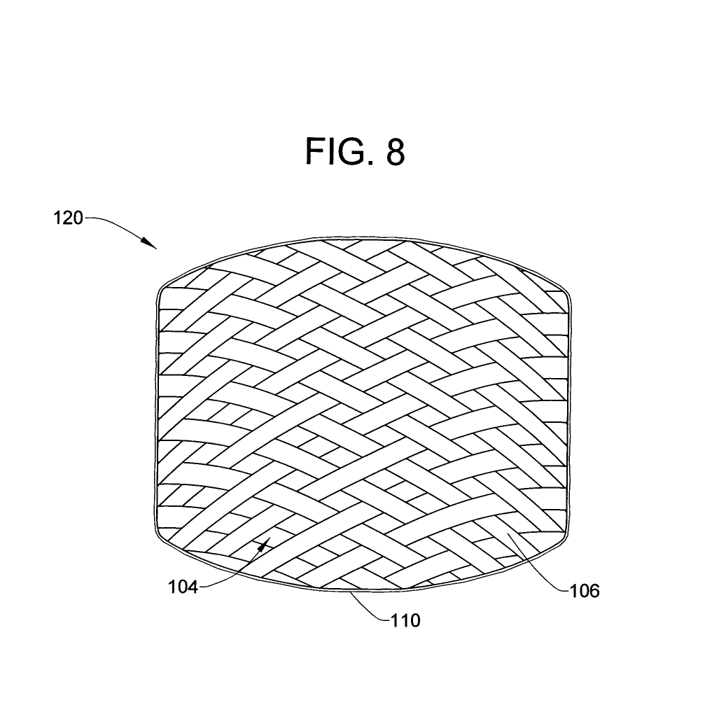

When employing dry or non-resin impregnated tow or roving to create un-cured slip cone preform 102, a resin 108 is supplied around and into slip cone material 50. Resin 108 may be infused into un-cured slip cone form 102 using a vacuum assisted resin transfer molding (VARTM) or other technique. Once infused with resin 108, a shrink wrap 110 may be applied to un-cured slip cone preform 102. Alternatively, if un-cured slip cone preform 102 is formed from wet tow or roving, or prepreg tow or roving, there is no need for a resin infusion process and un-cured slip cone preform 102 may simply be covered with shrink wrap 110. At this point, un-cured slip cone preform 102 is exposed to a curing process which may or may not include heating to form a cured slip cone preform 120. As such, slip cone preform 120 is formed from a cured resin material. Once cured, slip cone preform 120 is removed from mandrel 60, as shown in FIG. 8, and processed to form slip cones 28 as discussed below. Of course, it should be understood that slip cone preform 120 may also be cured while in mandrel 60, if desired.

Cured slip cone preform 120 may be divided into first and second slip cone portions 104 and 106 through, for example, a machining process. First and second slip cone portions 104 and 106 may be further machined to form two slip cones 28. The particular shape of each slip cone 28 may vary depending upon machining and selected application. It should be understood that the mandrel 60 may include a slip cone pre-form (not shown) that aids in forming the slip cone form. It should also be understood that the slip cone preform 120 may vary and could include metal-matrix and ceramic-matrix structures. Further, the use of a continuous fiber to create the slip cone preform 120 reduces manufacturing complexity and time which leads to reduced costs of the resulting slip cones.

In accordance with an aspect of an exemplary embodiment, slip cone preform 102 may be made by winding a band of carbon prepreg tow having a 0.25-inch (0.63-cm) width according to the following winding table:

Winding Table

| | Angle | Begin | | Nominal |
|---|---|---|---|---|
| Layer | (degrees) | (in) | End (in) | dia (in) |
| 1 | hoop | 28.95 | 31.05 | 2.56 |
| 2 | 66.7 | 29 | 31 | 3.398 |
| 3 | hoop | 28.91 | 31.09 | 2.68 |
| 4 | 34.7 | 28 | 32 | 3.45 |
| 5 | 36.5 | 28 | 32 | 3.615 |
| 6 | hoop | 28.6 | 31.4 | 3.22 |
| 7 | 39.6 | 27.5 | 32.5 | 3.654 |
| 8 | 41.1 | 27.25 | 32.75 | 3.71 |
| 9 | 42.6 | 27.89 | 32.11 | 3.762 |
| 10 | 46.7 | 28.375 | 31.625 | 3.776 |
| 11 | hoop | 29.625 | 30.375 | 3.273 |
| 12 | 31.4 | 28.6 | 31.4 | 3.84 |
| 13 | 41.1 | 29.08 | 30.92 | 3.995 |
| 14 | 40.5 | 28.2 | 31.8 | 4 |
| 15 | hoop | 28.25 | 31.75 | 3.393 |
| 16 | 29.9 | 27.58 | 32.42 | 4.016 |
| 17 | 29.2 | 27.821 | 32.179 | 4.094 |
| 18 | 41.7 | 27.4 | 32.6 | 4.146 |

While one or more embodiments have been shown and described, modifications and substitutions may be made thereto without departing from the spirit and scope of the invention. Accordingly, it is to be understood that the present invention has been described by way of illustrations and not limitation.

1. A method of forming a slip cone comprising:
winding a slip cone material onto a mandrel to create a slip cone preform having a plurality of layers, at least one of the plurality of layers being inclined relative to the mandrel; and
removing the slip cone preform from the mandrel; and
processing the slip cone preform to form at least one slip cone.

2. The method of claim 1, wherein winding the slip cone material onto the mandrel creates a slip cone form having a first slip cone portion and a second slip cone portion.

3. The method of claim 2, further comprising: cutting the slip cone form to separate the first slip cone portion from the second slip cone portion to create respective first and second slip cones.

4. The method of claim 1, wherein winding the slip cone material includes winding the slip cone material onto the mandrel at a substantially perpendicular angle relative to the mandrel to form a circular wind layer.

5. The method of claim 4, further comprising: winding the slip cone material at a non-perpendicular angle relative to the mandrel to form a helical wind layer over the circular wind layer, the helical wind layer being inclined relative to the mandrel.

6. The method of claim 4, further comprising: winding the slip cone material at a non-perpendicular angle relative to the mandrel to form a bottle wind layer over the circular wind layer, the bottle wind layer being inclined relative to the mandrel.

7. The method of claim 1, further comprising: impregnating the at least one slip cone with a resin.

8. The method of claim 1, further comprising: curing the resin impregnated into the at least one slip cone.

9. The method of claim 1, wherein winding the slip cone material onto the mandrel includes winding a resin impregnated fiber onto the slip cone form.

10. The method of claim 9, further comprising: curing the resin impregnated fiber.

11. The method of claim 1, wherein winding the slip cone material onto the mandrel includes winding one or more of a carbon fiber tow and a carbon fiber roving onto the slip cone form.

12. The method of claim 11, wherein winding the one of the carbon fiber tow and the carbon fiber roving includes winding one or more of a wet carbon fiber tow and a wet carbon fiber roving onto the slip cone form.

13. The method of claim 11, wherein winding the one of the carbon fiber tow and the carbon fiber roving includes winding one or more of a prepreg carbon fiber tow and a prepreg carbon fiber roving onto the slip cone form.

14. The method of claim 1, wherein winding the slip cone material onto the mandrel includes winding a continuous fiber onto the mandrel.

15. The method of claim 1, wherein winding the slip cone material onto the mandrel includes winding a discontinuous fiber onto the mandrel.

16. A slip cone comprising:
a body formed from a plurality of layered windings of a slip cone material, at least one of the layered windings being inclined relative to others of the plurality of windings.

17. The slip cone according to claim 16, wherein the plurality of layered windings includes one or more of a circular wind layer and one or more non-circular wind layers, the one or more non-circular wind layers being inclined relative to the one or more circular wind layers.

18. The slip cone according to claim 16 wherein the body further includes a cured resin material.

19. The slip cone according to claim 16, wherein the slip cone material comprises one or more of a carbon fiber tow and a carbon fiber roving.

20. A subsurface exploration system comprising:
an uphole system; and
a downhole system including at least one downhole tool, the at least one downhole tool including a slip cone comprising:
a body formed from a plurality of layered windings of slip cone material, at least one of the layered windings being inclined relative to others of the plurality of windings.

21. The subsurface exploration system according to claim 20, wherein the plurality of layered windings includes one or more of a circular wind layer and one or more non-circular wind layers, the one or more non-circular wind layers being inclined relative to the one or more circular wind layers.

22. The subsurface exploration system according to claim 20, wherein the slip cone material comprises one or more of a carbon fiber tow and a carbon fiber roving.
